(19) United States
(12) Patent Application Publication
(10) Pub. No.: US 2005/0017047 A1
(43) Pub. Date: Jan. 27, 2005

(54) Nail-guiding grooves of the nail cartridge of a nailing gun

(75) Inventor: Jerry Yao, Taichung (TW)

Correspondence Address: TROXELL LAW OFFICE PLLC;SUITE 1404, 5205 LEESBURG PIKE, FALLS CHURCH, VA, 22041, US

(73) Assignee: BENTLEY FASTENING TOOLS CO., LTD.

(21) Appl. No.: 10/623,492

(22) Filed: Jul. 22, 2003

(51) Int. Cl. B25C 5/02

(52) U.S. Cl. 227/109; 227/120

(57) ABSTRACT

The nail-guiding grooves of the nail cartridge of a nailing gun are respectively formed integral with a combining groove at a preset portion of one side on which the nail heads of a nail row rest. An abrasion-resisting plate of high strength and high wear-resistance is fixedly received in the combining groove. The nail heads of the nail row rest against the abrasion-resisting plate and shift thereon in the process of nail striking so as to avoid being worn out of the wall corners of the nail-guiding groove being worn out by the nail heads of the nail row, enabling the nail row shift and supply nails smoothly, preventing nails from being deadlocked and prolonging service life of the nail cartridge.

### BACHGROUND OF THE INVENTION

1. Field of the Invention

This invention relates a nailing gun, particularly to one having its nail cartridge provided inside with a plurality of reinforced nail-guiding grooves able to guide a nail row to shift smoothly and prevent nails from being deadlocked.

2. Description of the Prior Art

There are various operating modes for loading a nail row 20 in the nail cartridge 10 of a conventional nailing gun 1, as shown in FIG. 1. Generally. The nail box 10 of a conventional nailing gun is made of aluminum squeezed in shape or engineering plastic and formed inside with a plurality of nail-guiding grooves 11 of different widths for loading different-sized a nail row 20, which will be guided by the nail-guiding groove 11 to move upward to a nail-striking base to be driven into an object.

A common nail row 20 has its front edge formed with a plurality of sharp nail points and its rear edge formed with a plurality of serrated nail heads 21, which are positioned in and able to slide along the nail-guiding groove 11 of the nail cartridge 10, as shown in FIG. 2. During nail striking, the uppermost nail 22 of the nail row 20 is disengaged from the nail row 20 and driven into an object, and the nail row 20 is also affected to vibrate deflecting by a striking force on its upper end. Meanwhile, the allowance formed between the nail row 20 and the nail-guiding groove 11 will deflect slightly and the serrated nail heads 21 of the rowed nail 20 will closely push against the inner wall of the nail-guiding groove 11. Under the circumstances, when one round of nail striking is finished and the nail row 20 is moved upward to supply nails, the wall edge of the nail-guiding groove 11, especially the corners 111 of its upper edge, will be abraded by the nail heads 11 of the nail row 20. Thus, after the nail cartridge 10 has been used for a period of time, the opposite wall corners 111 of the nail-guiding groove 11 may be respectively abraded into a notch 112, rendering the nail row 20 unable to slide smoothly during shifting upward action of supply nails, as shown in FIG. 3.

Moreover, in case the gap between the two notches 112 respectively formed at the opposite wall corners 111 of the nail-guiding groove 11 is wider than the nail head 21 of the nail row 20, the nail head 21 is liable to be stuck immovable in the gap of the two notches 112 and the nail cartridge 10 becomes unable to supply nails any more. In addition, no nail cartridge 10 is sold alone on the market for the present. Therefore once the nail cartridge 10 gets out of order, the entire nailing gun will become useless, resulting in a great loss to consumers.

### SUMMARY OF THE INVENTION

The objective of the invention is to offer the structure of nail-guiding grooves of the nail cartridge of a nailing gun, respectively having a combining groove formed integral at one side on which the nail heads of a rowed nail rest. The combining groove is fixed inside with an abrasion-resisting plate of high strength and high wear resistance. Thus, during nail striking, the nail heads of the nail row can rest against the abrasion-resisting plate so as to prevent the wall corners of the nail-guiding groove from being worn out, preventing nails from being deadlocked, enabling the nail row to shift smoothly and prolonging service life of the nail cartridge.

### BRIEF DESCRIPTION OF DRAWINGS

This invention will be better understood by referring to the accompanying drawings, wherein:

FIG. 1 is a perspective view of a conventional nailing gun:

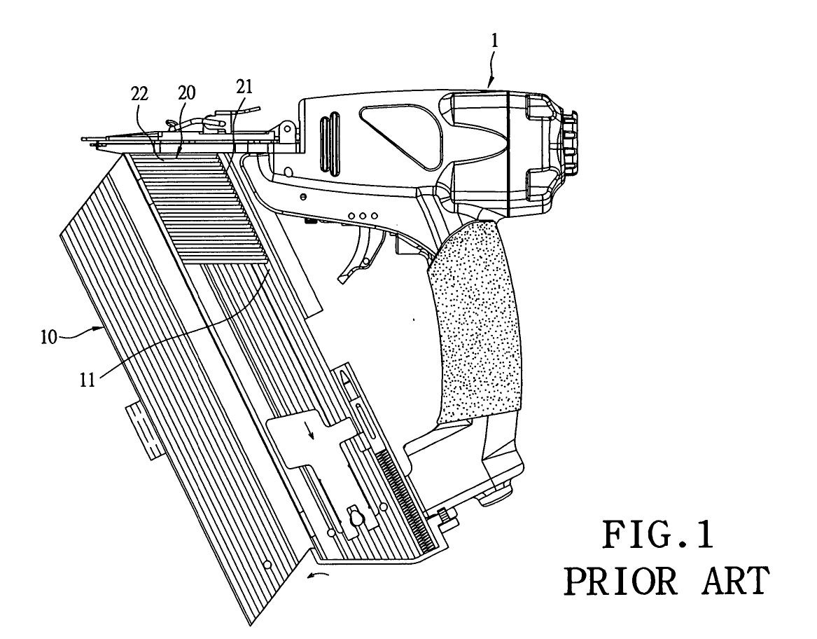

FIG. 2 is a partial side cross-sectional view of the nail box and the rowed nail of the conventional nailing gun:

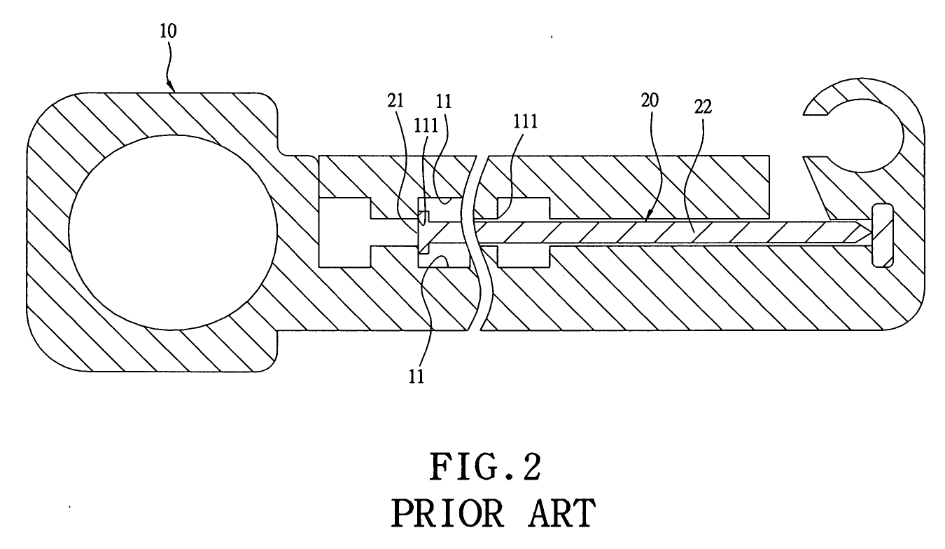

FIG. 3 is side cross-sectional view of the conventional nail-guiding grooves in a worn-out condition:

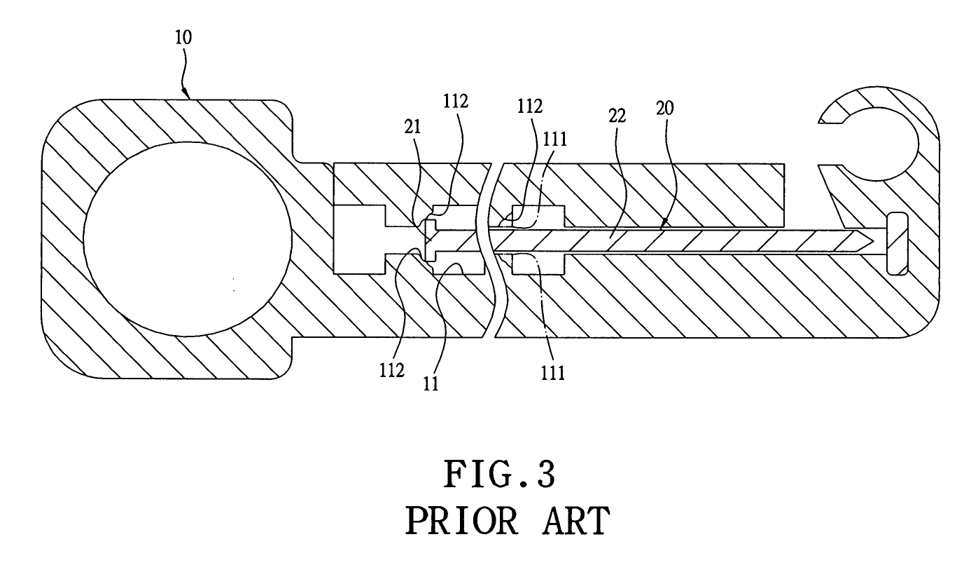

FIG. 4 is a partial perspective view of the nail cartridge of a nailing gun in the present invention:

FIG. 5 is a partial side cross-sectional view of the nail cartridge and the nail row of the nailing gun in the present invention:

FIG. 6 is a side cross-sectional view of the combining grooves and the abrasion-resisting plates combined together with the nail-guiding groove in the present invention: and

FIG. 7 is a side cross-sectional view of the abrasion-resisting plate installed at one side of the nail-guiding groove in the present invention.

### DETAILED DESCRIPTION OF THE PREFERRED EMBODIMENT

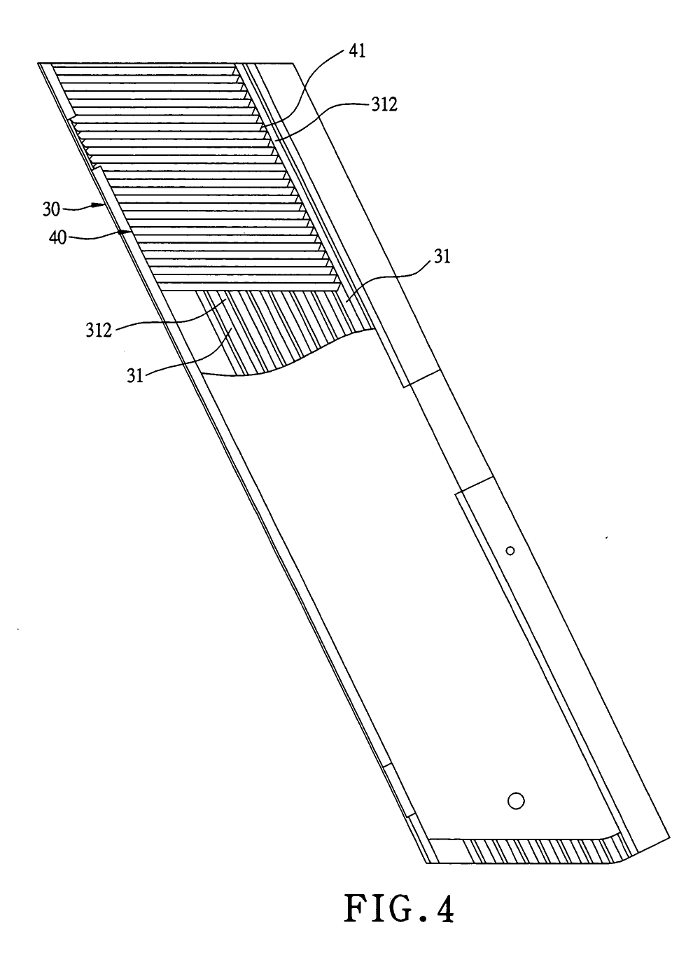

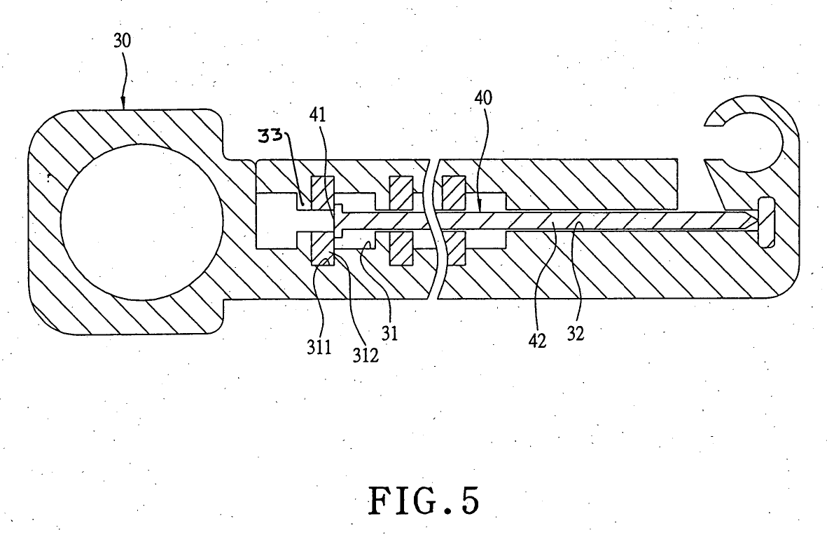

A preferred embodiment of the nail-guiding grooves of the nail cartridge of a nailing gun in the present invention, as shown in FIGS. 4 and 5, includes a nail cartridge 30 made of aluminum pressed into shape and formed inside with a plurality of symmetrical and parallel nail-guiding grooves 31 for receiving a nail row 40. Each nail-guiding groove 31 has the opposite edges of its one wall, on which the nail heads 41 of the nail row 40 rest, respectively formed integral with a combining groove 311 fixed inside with an abrasion-resisting plate 312 (a steel plate of high strength and high wear resistance used in this embodiment). The width of the combining groove 311 (or the abrasion-resisting plate 312) is about two thirds of the thickness of the wall between two adjacent nail-guiding grooves 31. Thus, when one round of nail striking is finished and the nail row 40 is moved upward to supply nails, the nail heads 41 of the nail row 40 can rest against the abrasion-resisting plate 312 and shift thereon to prevent the opposite wall corners of the nail-guiding groove 31 from being worn out by the nail heads 41 of the nail row 40 and enable the nail row 40 to move upward smoothly to supply nails. Besides, the nail-guiding groove 31 can always maintain a constant gap so the nail heads 41 can be avoided deadlocked when the nail row 40 is moved upward to supply nails.

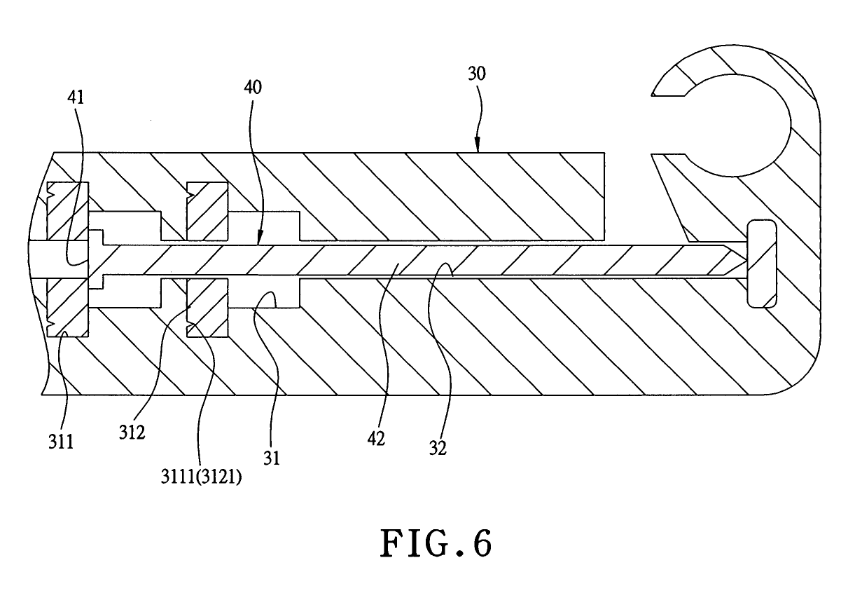

Further, as shown in FIG. 6, the combining groove 311 of the nail-guiding groove 31 in this invention has one side wall or two side walls respectively and laterally provided with a V-shaped or round-shaped positioning rib 3111 at a preset height, and the abrasion-resisting plate 312 has one side edge or two side edges respectively provided with a positioning groove 3121 matching with and having the same shape as the positioning rib 3111. Thus, the abrasion-resisting plate 312 can be laterally fixed with the combining groove 311 so as to reinforce their combination.

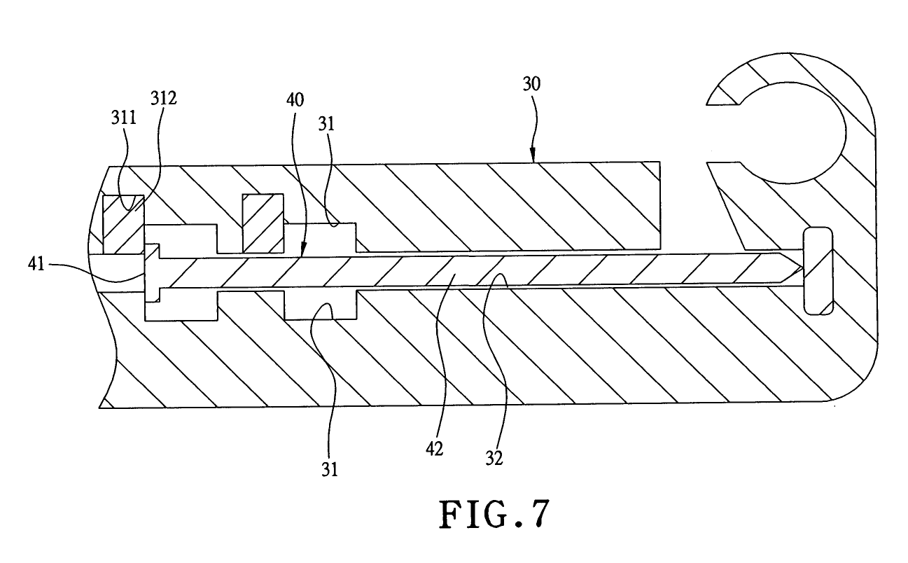

Furthermore, as shown in FIG. 7, the combining groove 311 of the nail-guiding groove 31 in this invention can only be provided at one side of the nail-guiding groove 31, on which the nail heads 41 of the nail row 40 rest, equally able to avoid nails being deadlocked. Substantially, the gap 32 between the nail 42 of the nail row 40 and the nail cartridge 30 is only about 0.3 mm wide, therefore the nail head 41 of the nail row 40 can shift right and left only within a very small extent. Under this condition, even if an abrasion-resisting plate 312 is only disposed at one side of the nail-guiding groove 31, the nail heads 41 of the nail row 40 can still always rest against and shift along the abrasion-resisting plate 312 with no possibility of being deadlocked, even though the other portion of the same side of the nail-guiding groove 31 is provided with no abrasion-resisting plate.

While the preferred embodiment of the invention has been described above, it will be recognized and understood that various modifications may be made therein and the appended claims are intended to cover all such modifications that may fall within the spirit and scope of the invention.

1-11. (Canceled)

12. A nail cartridge of a nail gun for a nail row comprising:
a plurality of parallel nail guiding-grooves symmetrically located on two opposing sides of an interior thereof, each of the plurality of parallel nail guiding-grooves located on at least one of the two opposing sides having:
a) at least one wall located between adjacent nail guiding grooves of the plurality of nail guiding-grooves;
b) a combining groove; and
c) an abrasion-resistant plate located in the combining groove adjacent to an adjacent wall of the at least one wall and having a rectangular cross section,
wherein at least one abrasive resistant plate engaging a top surface of nail heads of the nail row.

13. The nail cartridge according to claim 12, wherein the at least one of the two opposing sides of the interior includes both of the two opposing sides, a pair of abrasive resistant plates engaging the top surface of the nail heads of the nail row.

14. The nail cartridge according to claim 12, further comprising a positioning groove located in each combining groove on one of the at least one wall, and a positioning rib located on each abrasion-resistant plate, each positioning rib inserted into one positioning groove.

15. The nail cartridge according to claim 12, wherein each positioning groove and each positioning rib have a V-shaped cross section.

16. The nail cartridge according to claim 12, wherein the plurality of parallel nail guiding-grooves are integrally formed of an aluminum alloy.

17. The nail cartridge according to claim 12, wherein the plurality of parallel nail guiding-grooves are integrally formed of an engineering plastic material.

18. The nail cartridge according to claim 12, wherein the plurality of parallel nail guiding-grooves are integrally formed of an reinforced plastic material.

19. The nail cartridge according to claim 12, wherein each abrasion-resistant plate is a steel plate having a high strength and a high wear resistance.

20. The nail cartridge according to claim 12, wherein each abrasion-resistant plate has a thickness that is twice a thickness of the adjacent wall of each of the at least one wall.
